(19) United States
(12) Patent Application Publication
(10) Pub. No.: US 2017/0294139 A1
(43) Pub. Date: Oct. 12, 2017

(54) SYSTEMS AND METHODS FOR INDIVIDUALIZED DRIVER PREDICTION

(71) Applicant: TRUEMOTION, INC., Boston, MA (US)

(72) Inventors: Brad Cordova, Cambridge, MA (US); Rafi Finegold, Sharon, MA (US); Bill Kreamer, Melrose, MA (US); Shoko Ryu, Boston, MA (US)

(73) Assignee: TRUEMOTION, INC., Boston, MA (US)

(21) Appl. No.: 15/479,991

(22) Filed: Apr. 5, 2017

Related U.S. Application Data
(60) Provisional application No. 62/320,226, filed on Apr. 8, 2016.

(51) Int. Cl. G09B 19/16; G06N 5/04; G09B 7/06; H04M 1/725

(52) U.S. Cl. CPC G09B 19/167; H04M 1/72519; G06N 5/04; G09B 7/06

(57) ABSTRACT

Some embodiments of the present invention utilize mobile devices to make an individualized prediction regarding whether a user is a driver of a vehicle on a given driving event. For example, a mobile device carried by a user can be used to detect and analyze behavior indicative of driving. Driver predictions based on this behavior can be combined with a user-estimated driver valuation metric for all driving events to generate an individualized driver prediction for a particular driving event.

### CROSS-REFERENCES TO RELATED APPLICATIONS

This application claims the benefit of U.S. Provisional Patent Application No. 62/320,226, filed Apr. 8, 2016, entitled “SYSTEMS AND METHODS FOR INDIVIDUALIZED DRIVER PREDICTION”, which is herein incorporated by reference in its entirety.

### BACKGROUND OF THE INVENTION

Driving behavior has been a topic of interest. Some systems have been developed to track driving behaviors including speed, braking, and turn speed. External devices have been integrated with vehicles to track driving behavior.

Despite the progress made in relation to collecting data related to drivers and their driving behavior, there is a need in the art for improved methods and systems related to individualized driver prediction.

### SUMMARY OF THE INVENTION

Provided are methods, including computer-implemented methods, devices including mobile devices, and computer-program products for detecting device usage.

Embodiments of the present invention utilize mobile devices to provide information on a user's behaviors during transportation. For example, sensors in a mobile device carried by a user can be used to determine whether a user is driving a vehicle. The mobile device can further be used to receive input from the user regarding his or her driving habits to make an individualized determination of whether the user of the mobile device is likely a driver for a given trip.

According to some embodiments of the invention, a method is provided. The method comprises receiving a driver valuation metric corresponding to a percentage of driving events during which a user is a driver of a vehicle as a function of a total number of driving events during which the user is in the vehicle. The method further comprises determining, using the driver valuation metric, a first probability that the user will be driving the vehicle during a next driving event. The method further comprises obtaining a first stream of data from a sensor of a mobile device of the user. The method further comprises determining from the first stream of data that the next driving event has initiated. The method further comprises obtaining a second stream of data from the sensor of the mobile device of the user during the next driving event. The method further comprises determining, using the second stream of data, a second probability that the user is driving the vehicle during the next driving event. The method further comprises determining, using the first probability and the second probability, a combined probability that the user is driving the vehicle during the next driving event.

According to some embodiments of the invention, a method is provided. The method comprises facilitating display of a survey question on a mobile device. The method further comprises receiving input indicative of an answer to the survey question on the mobile device. The method further comprises correlating the answer to the survey question to a driver valuation metric, wherein the driver valuation metric corresponds to an amount of driving events during which a user if a driver of a vehicle as a function of a total number of driving events during which the user is in the vehicle. The method further comprises determining, using the driver valuation metric, a first probability that the user will be driving the vehicle during a next driving event. The method further comprises obtaining a first stream of data from a sensor of a plurality of sensors of the mobile device. The method further comprises determining from the first stream of data that the next driving event has initiated. The method further comprises obtaining a second stream of data from the sensor of the plurality of sensors of the mobile device during the next driving event. The method further comprises determining, using the second stream of data, a second probability that the user is driving the vehicle during the next driving event. The method further comprises determining, using the first probability and the second probability, a combined probability that the user is driving the vehicle during the next driving event.

According to some embodiments of the invention, a system is provided. The system comprises a mobile device comprising a plurality of sensors. The plurality of sensors comprises an accelerometer, a gyroscope, a magnetometer, a GPS, and a compass. The system further comprises a memory. The system further comprises a processor coupled to the memory. The processor is configured to perform operations including the steps of the above methods.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a system diagram illustrating an individualized driver prediction system according to some embodiments of the invention.

FIG. 2 is a system diagram illustrating an individualized driver prediction system according to some embodiments of the invention.

FIG. 3 is a flowchart illustrating an individualized driver prediction method according to some embodiments of the invention.

FIG. 4 is a flowchart illustrating an individualized driver prediction method according to some embodiments of the invention.

FIG. 5 is a flowchart illustrating a method for adjusting a user-estimated driver valuation metric according to some embodiments of the invention.

FIG. 6A is a flowchart illustrating a method for calculating a driver valuation metric using survey answers according to some embodiments of the invention.

FIG. 6B is a flowchart illustrating a method for adjusting a user-estimated driver valuation metric using survey answers according to some embodiments of the invention.

FIG. 7 is a screen shot of an interface for inputting a user-estimated driver valuation metric according to some embodiments of the invention.

FIG. 8 is a scatter plot comparing user-estimated driver valuation metrics (e.g., rates) to actual driver valuation metrics (e.g., rates) according to some embodiments of the invention.

In the appended figures, similar components and/or features can have the same reference label. Further, various components of the same type can be distinguished by following the reference label with a dash and a second label that distinguishes among the similar components. If only the first reference label is used in the specification, the description is applicable to any one of the similar components having the same first reference label irrespective of the second reference label.

### DETAILED DESCRIPTION OF SPECIFIC EMBODIMENTS

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Some embodiments of the present invention utilize mobile devices to provide information on a user's behaviors during transportation. For example, a mobile device carried by a user could be used to determine a probability that the user is driving on one or more trips. Once a user is identified as a driver, information regarding the trip can be analyzed to draw conclusions about the user's driving habits, such as frequent hard braking, speeding, accidents, device usage behavior, device interaction behavior, and other types of distraction or inattentiveness to driving tasks. These conclusions may be used to generate alerts to the driver, score driving behavior on trips, and provide feedback to the user and/or to third parties.

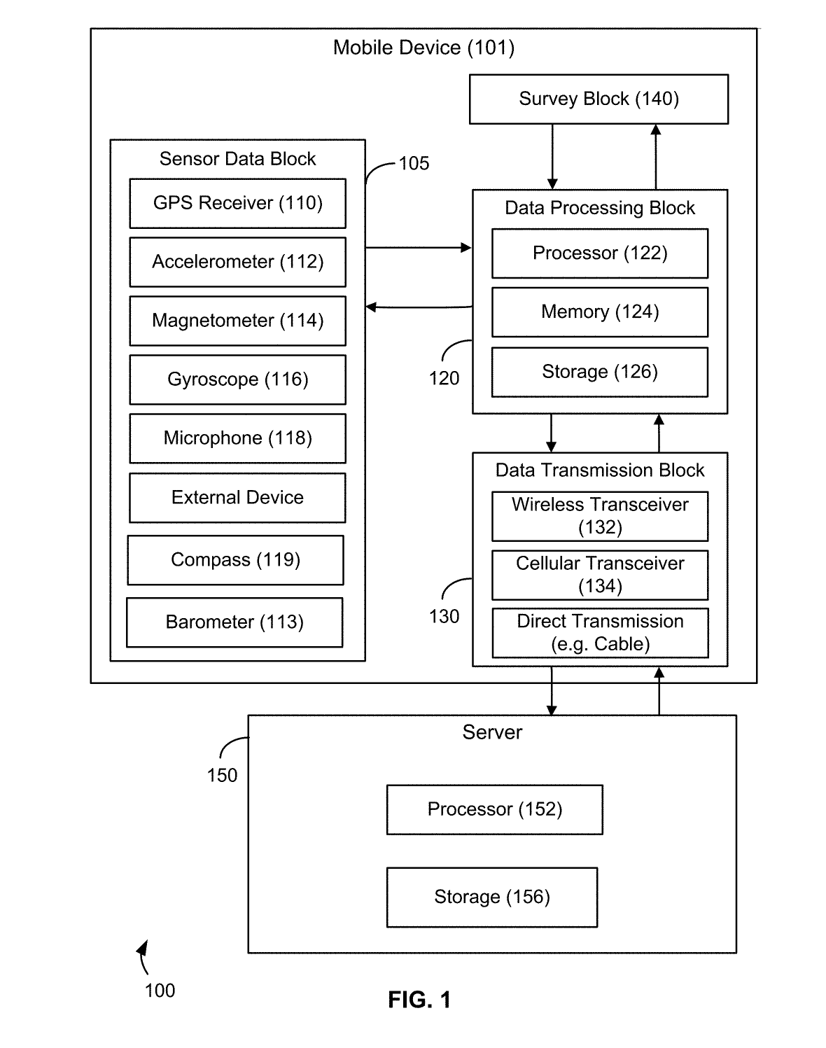

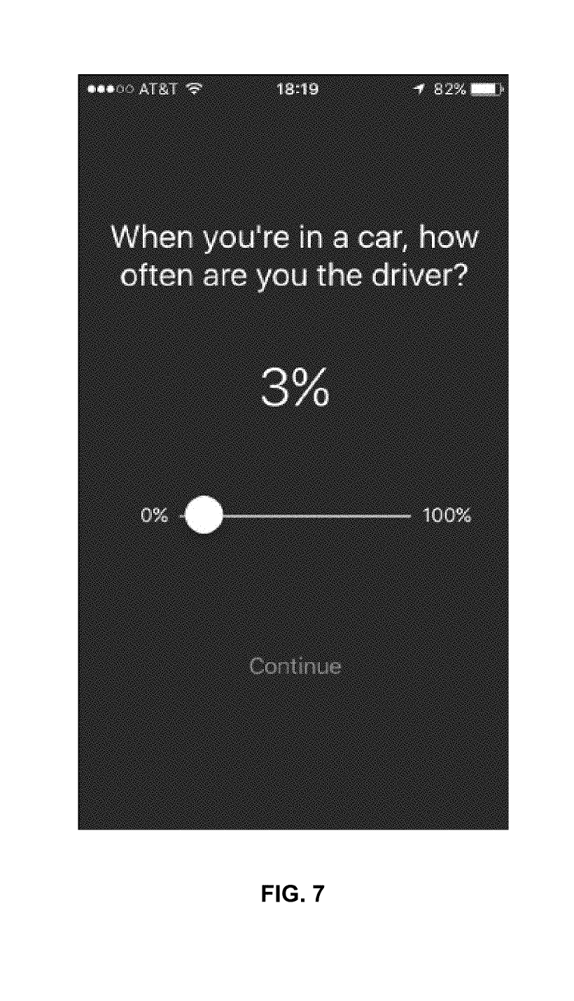

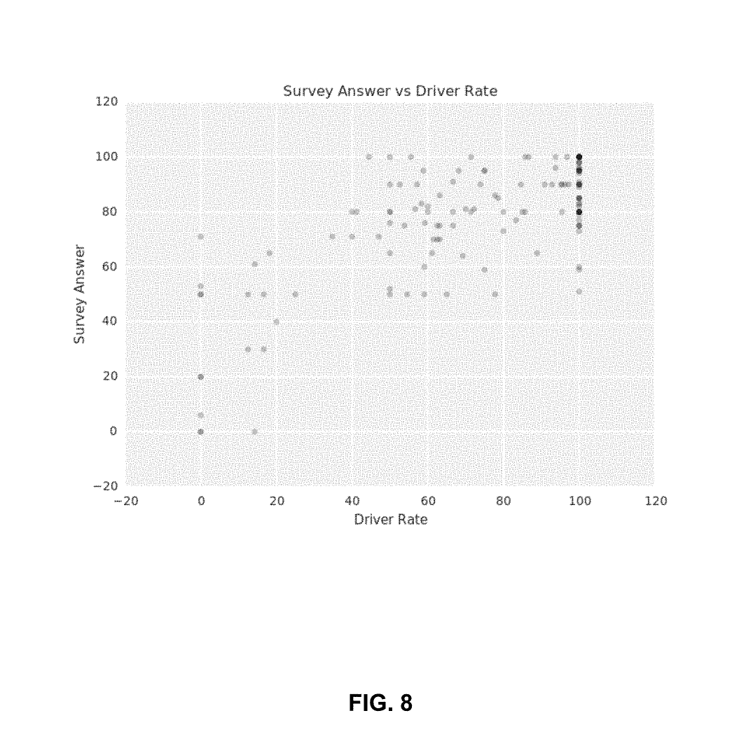

FIG. 1 is a system diagram illustrating a system 100 for collecting driving data according to an embodiment of the present invention. System 100 includes a mobile device 101 having a number of different components. Mobile device 101 includes a sensor data block 105, a data processing block 120, a data transmission block 130, and a survey block 140. The sensor data block 105 includes data collection sensors as well as data collected from these sensors that are available to mobile device 101. This can include external devices connected via Bluetooth, USB cable, etc. The data processing block 120 includes storage 126, and manipulations done to the data obtained from the sensor data block 105 by processor 122. This includes, but is not limited to, analyzing, classifying, characterizing, subsampling, filtering, reformatting, etc. Data transmission block 130 includes any transmission of the data off the phone to an external computing device that can also store and manipulate the data obtained from sensor data block 105. The external computing device can be, for example, a server 150. Server 150 can comprise its own processor 152 and storage 156. In one embodiment, survey block 140 presents a survey to a user of mobile device 101 via a display (not shown). The survey may, for example, prompt the user to estimate his or her driver valuation metric for all trips taken in vehicles. An exemplary survey of this type is shown in FIG. 7. In an additional or alternative example, the survey may prompt the user to answer one or more of a series of driving-related or demographic questions.

Some embodiments of the present invention are described using examples where driving data is collected using mobile devices 101, and these examples are not limited to any particular mobile device. As examples, a variety of sensors such as accelerometers 112, gyroscopes 116, magnetometers 114, microphones 118, compasses 119, barometers 113, location determination systems such as global positioning system (GPS) receivers 110, communications capabilities, and the like may be included in a mobile device 101. Exemplary mobile devices 101 include smart watches, fitness monitors, Bluetooth headsets, tablets, laptop computers, phones (including cell phones, smart phones, etc.), music players, movement analysis devices, and other suitable devices. One of ordinary skill in the art, given the description herein, would recognize many variations, modifications, and alternatives for the implementation of embodiments.

To collect data associated with the driving behavior of a driver (and data indicative of driver prediction), one or more sensors on mobile device 101 (e.g., the sensors of sensor data block 105) are operated close in time to a period when mobile device 101 is with a driver when operating a vehicle—also termed herein “a drive”, “a trip” or a “driving event”. With many mobile devices 101, the sensors used to collect data are components of the mobile device 101, and use power resources available to mobile device 101 components, e.g., mobile device battery power and/or a power source external to mobile device 101.

Some embodiments use settings of a mobile device to enable different functions described herein. For example, in Apple iOS, and/or Android OS, having certain settings enabled can enable certain functions of embodiments. For some embodiments, having location services enabled allows the collection of location information from the mobile device (e.g., collected by global positioning system (GPS) sensors), and enabling background app refresh allows some embodiments to execute in the background, collecting and analyzing driving data even when the application is not executing.

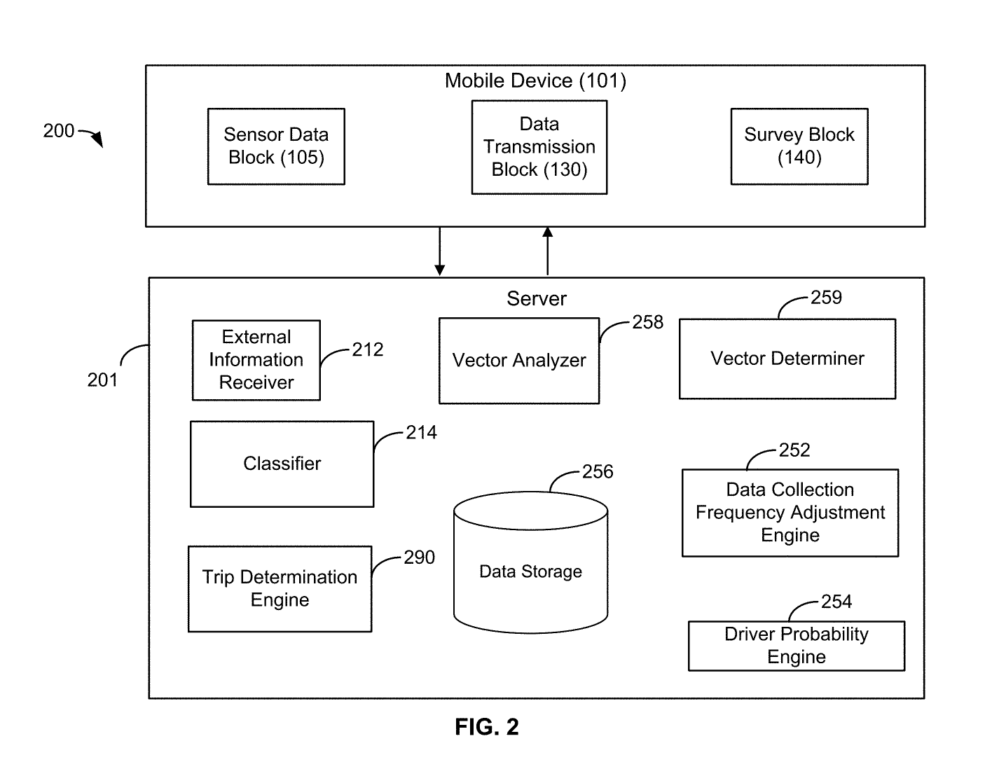

FIG. 2 shows a system 200 for collecting driving data that can include a server 201 that communicates with mobile device 101. In some embodiments, server 201 provides functionality using components including, but not limited to vector analyzer 258, vector determiner 259, external information receiver 212, classifier 214, data collection frequency engine 252, trip determination engine 290, and driver probability engine 254. These components are executed by processors (not shown) in conjunction with memory (not shown). Server 201 also includes data storage 256. It is important to note that, while not shown, one or more of the components shown operating within server 201 can operate fully or partially within mobile device 101.

To collect data associated with the driving behavior of a driver, one or more sensors on mobile device 101 (e.g., the sensors of sensor data block 105) are operated close in time to a period when mobile device 101 is with the driver when operating a vehicle—also termed herein “a drive”, “a trip” or “a driving event”. Once the mobile device sensors have collected data (and/or in real time), some embodiments analyze the data to determine acceleration vectors for the vehicle, as well as different features of the drive. Examples of processes to detect and classify driving features using classifier 214, and determine acceleration vectors using vector analyzer 258 and vector determiner 259. In some embodiments, external data (e.g., weather) can be retrieved and correlated with collected driving data.

As discussed herein, some embodiments can transform collected sensor data (e.g., driving data collected using sensor data block 105) into different results, including, but not limited to, probabilities of whether a user of mobile device 101 is the driver. Examples of collecting driving data using sensors of a mobile device are described herein. Examples of analyzing collected driving data to make driver predictions are also described herein. A user-estimated driver valuation metric for all trips in vehicles can be collected via survey block 140 of mobile device 101 in some embodiments. In some embodiments, other survey data (e.g., demographic data or driving-related data) may be collected via survey block 140 of mobile device 101, additionally or alternatively.

Although shown and described as being contained within server 201, it is contemplated that any or all of the components of server 201 may instead be implemented within mobile device 101, or vice versa. It is further contemplated that any or all of the functionalities described herein may be performed during a drive, in real time, or after a drive.

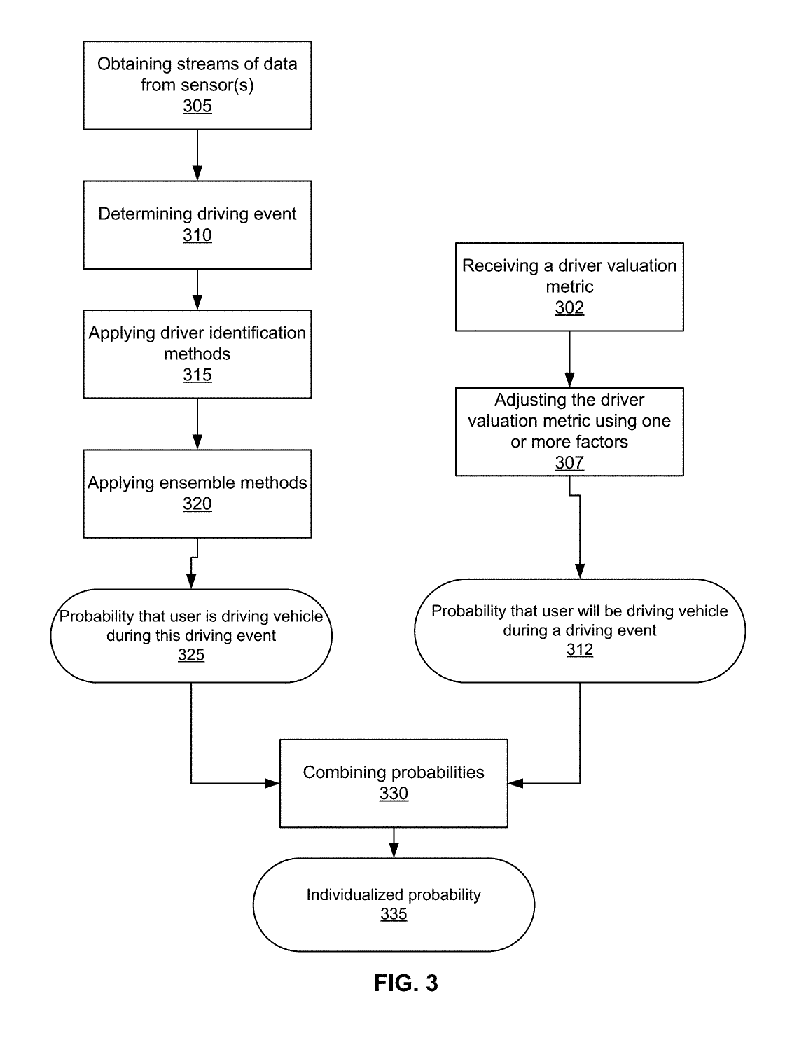

FIG. 3 is a flowchart illustrating an individualized driver prediction method according to an embodiment of the invention. The method may be performed by mobile device 101 and/or server 150 of FIG. 1, or mobile device 101 and/or server 201 of FIG. 2, for example. At processing block 305, streams of data are obtained from one or more sensors of the mobile device. The streams of data may be obtained by one or more sensors within sensor data block 105 of FIG. 1, such as the accelerometer, the gyroscope, the GPS and/or the magnetometer. The measurements may include, for example, the non-gravitational acceleration of the device in the x, y, and z directions; the gravitational acceleration of the phone in the x, y, and z directions; the yaw, roll, and pitch of the device; the derivatives of these measurements; the gravity difference angle of the device; and the difference in normed gravitational acceleration of the device. In some embodiments, the streams of data may comprise measurements taken from one or more sensors in intervals, e.g., every 1 second.

At processing block 310, a driving event is determined based on the streams of data from the sensor(s). A driving event may be determined based on the speed, trajectory, and/or patterns of the streams of data, for example, if such data is consistent with a driving event (e.g., a trip in a car). Further, a driving event may be determined by excluding trips having sensor data streams more closely associated with plane trips, train trips, bus trips, bike trips, walking trips, or other public transportation trips. Methods and systems for making these determinations are disclosed in U.S. patent application Ser. No. 15/149,628, filed May 9, 2016, entitled “MOTION DETECTION SYSTEM FOR TRANSPORTATION MODE ANALYSIS”, herein incorporated by reference in its entirety.

At processing block 315, one or more driver identification methods are applied to the streams of sensor data associated with the driving event. The driver identification methods may include determining whether the user entered the car from a left side or a right side of the car; determining whether the user exited the car from the left side or the right side of the car; determining usage of the mobile device by the user; determining a fraction of the trip during which a battery of the mobile device is being charged; and/or determining whether the mobile device is connected to hands-free technology in the car. Various driver identification methods are described in detail in U.S. patent application Ser. No. 14/139,510, filed Dec. 23, 2013, entitled “METHODS AND SYSTEMS FOR DRIVER IDENTIFICATION”; U.S. patent application Ser. No. 14/192,452, filed Feb. 27, 2014, entitled “METHODS AND SYSTEMS FOR DRIVER IDENTIFICATION”, now U.S. Pat. No. 8,862,486; U.S. patent application Ser. No. 14/477,519, filed Sep. 4, 2014, entitled “METHODS AND SYSTEMS FOR DRIVER IDENTIFICATION”; and U.S. patent application Ser. No. 15/268,049, filed Apr. 6, 2016, entitled “SYSTEMS AND METHODS FOR DETECTING AND ASSESSING DISTRACTED DRIVERS”, which are herein incorporated by reference in their entireties. The applied driver identification method(s) each provide as an output a probability that the user is driving the vehicle during the driving event based on the streams of data from the sensor(s).

At processing block 320, an ensemble method is applied to the one or more probabilities that the user is driving the vehicle during the driving event based on the streams of data from the sensor(s), as output by the driver identification method(s). The ensemble method may weigh and/or combine the probabilities in order to generate an overall probability that the user is driving the vehicle during this driving event based on the streams of data from the sensor(s) at block 325. In some embodiments, the probabilities may each be weighed equally, and may be combined by multiplying each of the probabilities. In some embodiments, the probabilities may be weighed differently based on the determined accuracy of the particular driver identification method. For example, if data indicates that streams of data from sensor(s) indicating a left hand entry and exit accurately identify a driver 99% of the time, it may be weighed higher. If data indicates that use of hands-free technology only accurately identifies a driver 50% of the time, it may be weighed lower.

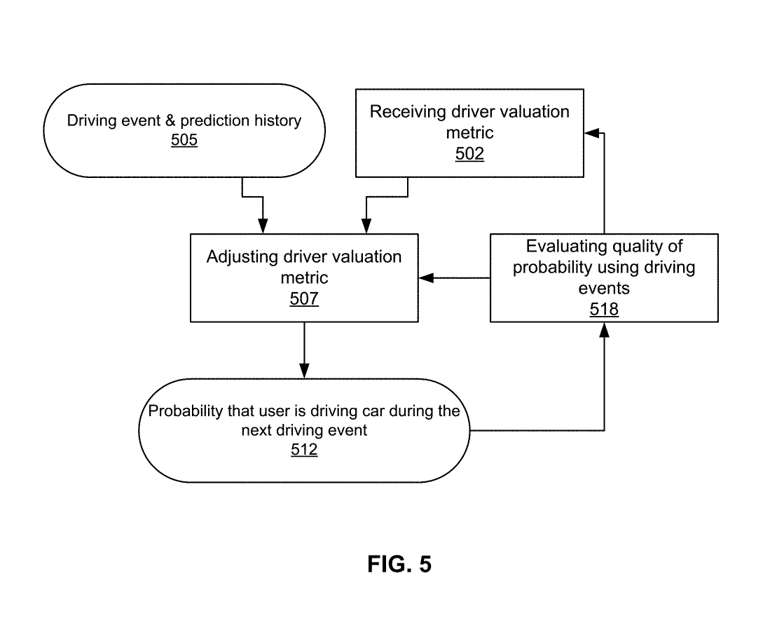

At some point before, during, or after steps 305-320, a driver valuation metric is received corresponding to a percentage (or other indicator) of driving events during which the user is the driver of the vehicle as a function of a total number of driving events during which the user is in the vehicle, at processing block 302. The driver valuation metric may be received as input from the user. For example, the user may be prompted with a survey on the mobile device asking how often s/he drives when s/he is in the car. An exemplary interface for inputting a driver valuation metric is shown in FIG. 7. Although shown as a range between 0% and 100%, it is contemplated that any range, any numbers, any letters, and/or any characters or images may be used to indicate the driver valuation metric. Further, it is contemplated that the user may input a driver valuation metric once or multiple times (e.g., after every driving event, after every 10 driving events, once a week, etc.), as described further herein with respect to FIG. 5.

Turning back to FIG. 3, at processing block 307, the driver valuation metric is optionally adjusted using one or more factors, producing the probability 312 that the user is driving the vehicle during a next driving event. Processing block 307 is optional in that, in one embodiment, the driver valuation metric can be used as the driver probability 312 without any adjustment.

One exemplary factor for adjusting the driver valuation metric is the amount of time elapsed between displaying the survey to the user and receiving the input from the user. If the amount of time is above a threshold, the driver valuation metric may be considered more likely to be accurate, and therefore should not be adjusted or be adjusted less. If the amount of time is below a threshold, the driver valuation metric may be considered less likely to be accurate, and therefore should be adjusted more.

An additional or alternative exemplary factor is the user's historical driver valuation metric as determined from historical streams of data taken from sensor(s) on past driving events. For example, if the user historically drove 75% of the time based on historical sensor data and applied driver identification methods, but estimated his or her driver valuation metric at 100%, the driver valuation metric can be adjusted closer to 75%, particularly if the user input is received below a threshold amount of time.

Another exemplary factor is the actual historical driver valuation metric for a plurality of users, as compared to the users' estimated driver valuation metric. A scatter plot comparing user-estimated driver valuation metrics (e.g., driver rates) to actual driver valuation metrics (e.g., driver rates), as reported by the users after each driving event, is shown in FIG. 9. As shown in FIG. 9, a large number of users that estimated their driver valuation metric at 80% actually drove 100% of the time. In this example, if a user estimates his or her driver valuation metric at 80%, the driver valuation metric can be adjusted closer to 100%, particularly if the user input is received below the threshold.

At processing block 330, the probability 325 that the user is driving the vehicle during this driving event based on sensor data is combined with the probability 312 that the user is driving the vehicle during the next driving event based on the adjusted driver valuation metric. In one embodiment, the probabilities 312, 325 may be multiplied to produce a single individualized probability 335. In another embodiment, the probabilities 312, 325 may be weighed before they are combined. For example, if probability 325 is determined to be more likely to be accurate than probability 312, then probability 325 may be weighed higher in determining the individualized probability 335.

Once an individualized probability 335 is established that the user is the driver during this driving event, information regarding the driving event can be analyzed to draw conclusions about the user's driving habits, such as frequent hard braking, speeding, accidents, device usage behavior, device interaction behavior, and other types of distraction or inattentiveness to driving tasks. For example, additional information may be collected and analyzed if the individualized probability 335 is above a threshold, e.g., 50%. Any conclusions drawn from this analysis may be used to generate alerts to the driver, score driving behavior on trips, and provide feedback to insurance companies. Further disclosure regarding how this information may be used can be found in U.S. patent application Ser. No. 15/268,049, filed Sep. 16, 2016, entitled “SYSTEMS AND METHODS FOR DETECTING AND ASSESSING DISTRACTED DRIVERS”, U.S. patent application Ser. No. 15/249,967, filed Aug. 29, 2016, entitled “METHODS AND SYSTEMS FOR PRESENTING COLLECTED DRIVING DATA”, U.S. patent application Ser. No. 15/413,005, filed Jan. 23, 2017, entitled “SYSTEMS AND METHODS FOR SENSOR-BASED DETECTION, ALERTING AND MODIFICATION OF DRIVING BEHAVIORS”, U.S. Provisional Patent Application No. 62/353,455, filed Jun. 22, 2016, entitled “SYSTEMS AND METHODS FOR DETECTING DEVICE USAGE”, and in U.S. Provisional Patent Application No. 62/346,013, filed Jun. 6, 2016, entitled “SYSTEMS AND METHODS FOR SCORING DRIVING TRIPS”, which are herein incorporated by reference in their entireties.

In some embodiments, one or more changes to the mobile device may be effected based on an identification that a user is likely to be the driver according to any of the embodiments described herein. For example, the mobile device may have been collecting sensor data at a first frequency at processing block 305. This frequency may be selected, for example, as a minimum rate at which data can be collected and analyzed to establish driver identification. Once the user is identified as a likely driver, the sensor data may be collected at a second frequency different than the first frequency. For example, the second frequency may be higher than the first frequency in order to collect accurate data regarding driving behaviors, such as hard braking, speeding, and the like. In another example, the second frequency may be lower than the first frequency, such as if the user is a safe driver according to past sensor data and analysis. If the user is identified as unlikely to be a driver, the sensor data may be collected at a third frequency. For example, the third frequency may be lower than the first frequency (or may be zero), because passenger data may be of little interest because it is not indicative of the user's driving behavior.

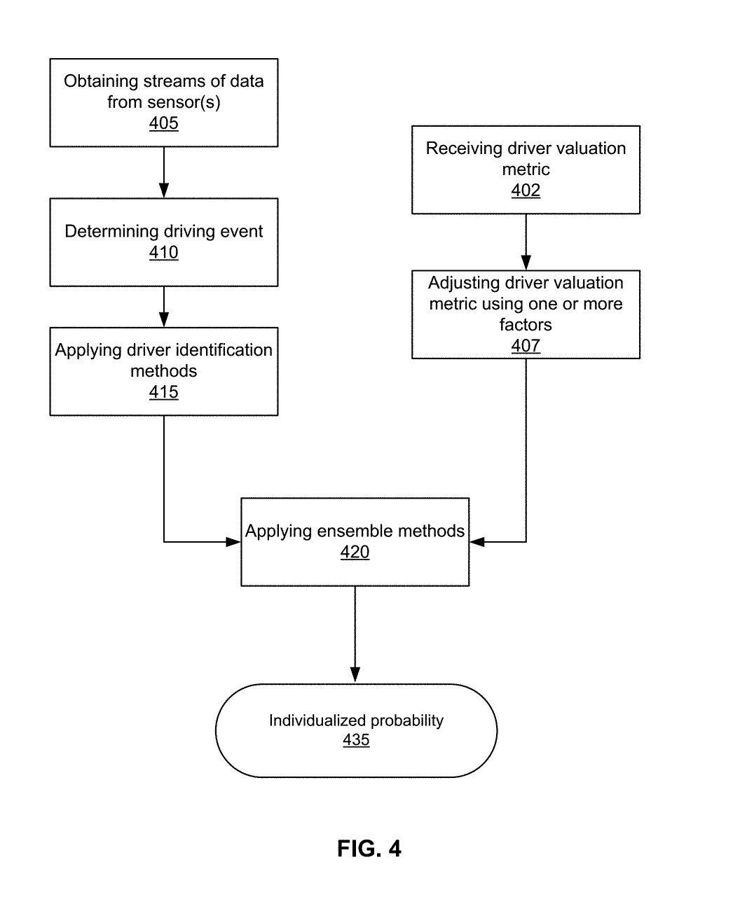

FIG. 4 is a flowchart illustrating another individualized driver prediction method according to some embodiments of the invention. The method may be performed by mobile device 101 and/or server 150 of FIG. 1, or mobile device 101 and/or server 201 of FIG. 2, for example. At processing block 405, streams of data are obtained from sensor(s). At processing block 410, a driving event is determined based on the streams of data. At processing block 415, one or more driver identification methods are applied to the streams of data associated with the driving event. Processing blocks 405-415 of FIG. 4 may correspond to processing blocks 305-315 of FIG. 3.

At some point before, during, or after steps 405-415, a driver valuation metric is received corresponding to a percentage (or other indicator) of driving events during which the user is the driver of the vehicle as a function of a total number of driving events during which the user is in the vehicle, at processing block 402. The driver valuation metric may be received as user input, for example. At processing block 407, the driver valuation metric is optionally adjusted using one or more factors. Processing blocks 402, 407 of FIG. 4 may correspond to processing blocks 302, 307 of FIG. 3.

At processing block 420, an ensemble method is applied to the one or more probabilities that the user is the driver during this driving event based on the streams of data from the sensor(s), and as output by the driver identification method(s), as well as to the adjusted driver valuation metric. The ensemble method may weigh and/or combine the probabilities in order to generate an overall individualized probability 435 that the user is driving the car during this driving event at block 435. In some embodiments, the probabilities may each be weighed equally, and may be combined by multiplying each of the probabilities. In another embodiment, the probabilities may be weighed differently based on the determined accuracy of the particular driver identification method. For example, if data indicates that sensor data indicating a left hand entry and exit accurately identify a driver 99% of the time, it may be weighed higher. If data indicates that the adjusted driver valuation metric only accurately identifies a driver 50% of the time, it may be weighed lower.

Once an individualized probability 435 is established that the user is the driver, information regarding the driving event can be analyzed to draw conclusions about the user's driving habits, such as frequent hard braking, speeding, accidents, device usage behavior, device interaction behavior, and other types of distraction or inattentiveness to driving tasks. For example, additional information may be collected and analyzed if the individualized probability 335 is above a threshold, e.g., 50%. Any conclusions drawn from this analysis may be used to generate alerts to the driver, score driving behavior on trips, and provide feedback to insurance companies. Further disclosure regarding how this information may be used can be found in applications incorporated by reference herein.

FIG. 5 is a flowchart illustrating a method for adjusting a driver valuation metric according to some embodiments of the invention. The method may be performed by mobile device 101 and/or server 150 of FIG. 1, or mobile device 101 and/or server 201 of FIG. 2, for example. The method of FIG. 5 may be performed at blocks 302, 307, 312 of FIG. 3, and/or blocks 402, 407 of FIG. 4, for example.

At processing block 502, a driver valuation metric is received corresponding to a percentage (or other indicator) of driving events during which the user is the driver of the vehicle as a function of a total number of driving events during which the user is in the vehicle. The driver valuation metric may be received as user input. For example, the user may be prompted with a survey on the mobile device (or any other device) asking how often s/he drives when s/he is in the vehicle. An exemplary interface for inputting a driver valuation metric is shown in FIG. 7. Although shown as a range between 0% and 100%, it is contemplated that any range, any numbers, any letters, and/or any characters or images may be used to indicate the driver valuation metric.

At processing block 507, the driver valuation metric is adjusted using driving event and prediction history 505. Driving event and prediction history 505 may contain historical sensor data for a plurality of past driving events, as well as driver predictions for each driving event based on the historical sensor data. These driver predictions may be used to determine the user's historical driver valuation metric for the plurality of driving events. This historical driver valuation metric can then be used to adjust the received driver valuation metric. For example, if the user historically drove 75% of the time based on historical sensor data and applied driver identification methods, but the user estimated his or her driver valuation metric at 100%, the driver valuation metric can be adjusted closer to 75%. Thus, a probability 512 that the user will be the driver on the next trip may be determined based on the adjusted driver valuation metric.

At processing block 518, the quality of the probability 512 is evaluated using future driving events. For example, if the probability 512 that the user is the driver is 75%, sensor data for future driving events can be taken and driver identification methods applied to determine whether the user drives during 75% of all driving events. At processing block 507, the estimated driver valuation metric can again be adjusted based on this determination. For example, if sensor data for future driving events indicate that the user is a driver 80% of the time, the estimated driver valuation metric can be adjusted closer to 80% at processing block 507.

Further, the output of processing block 518 can be used to determine whether to prompt the user for further input regarding the driver valuation metric again at processing block 502. In some embodiments, if the initial probability 512 is substantially inaccurate as shown by sensor data on future driving events at block 518, the user can again be prompted to estimate his or her driver valuation metric at processing block 502. For example, if the probability 512 is 100%, but sensor data from future driving events indicate that the user is the driver 0% of the time, the user may be presented with another survey to establish a more accurate probability 512. In this example, the user may have moved from the suburbs (e.g., driving 100% of the time) to the city (e.g., driving 0% of the time), and an updated survey response could reflect this change.

The method may then repeat and continue as shown in FIG. 5. The method of FIG. 5 may be repeated continuously, or may stop after the fulfillment of one or more conditions. For example, the method may be stopped once the quality of the probability 512 is sufficiently high, as established at processing block 518. In another example, the method of FIG. 5 may be repeated at intervals, such as after every 10 driving events, or once a week.

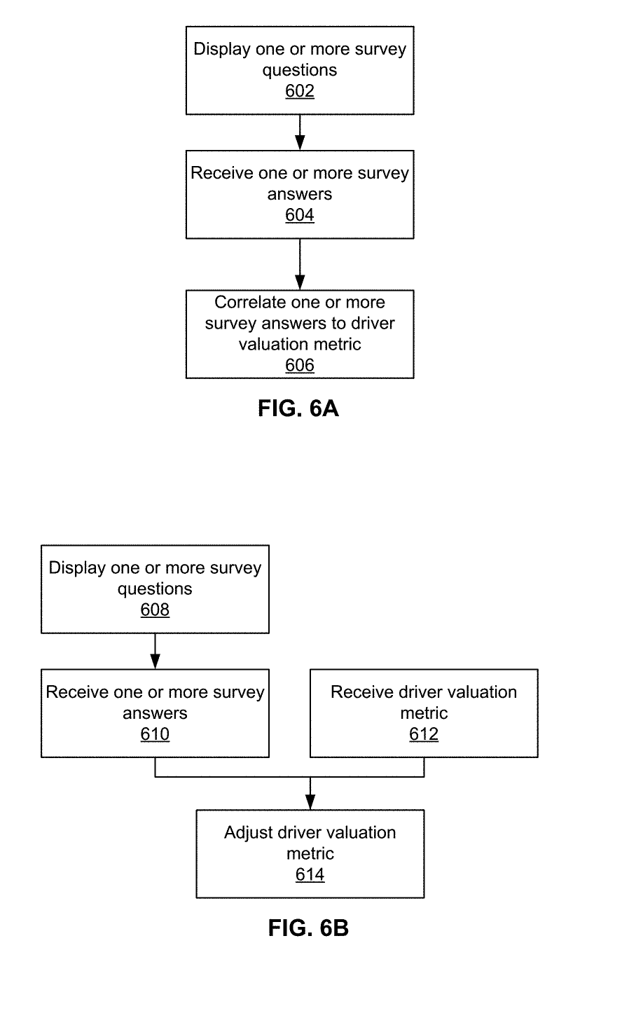

FIG. 6A is a flowchart illustrating a method for calculating a driver valuation metric using survey answers according to some embodiments of the invention. The method may be performed by mobile device 101 and/or server 150 of FIG. 1, or mobile device 101 and/or server 201 of FIG. 2, for example. The method of FIG. 6A may be implemented in conjunction with or alternative to any portions of any of the embodiments described herein.

In some embodiments, instead of receiving a driver valuation metric from a user, the driver valuation metric may be calculated or estimated based on one or more survey questions. At processing block 602, one or more survey questions may be displayed on the mobile device.

The survey questions may be demographic questions and/or driving-related questions that may be indicative of how often a user is a driver. For example, the survey questions may include one or more of: “How many cars are there in your household?”, “Do you live alone?”, “Does anybody other than you drive the car that you drive?”, “Are you a stay-at-home parent?”, “Are you a parent or guardian to children living with you?”, “Do you drive yourself to work or school on most weekdays?”, “How many days a week do you drive yourself for your commute to work or school?”, “If you have kids, how often do you drive them to school or other activities?”, “For weekend car trips, do you do most of the driving?”, “How many drivers are there in your household?”, “What kind of area is your work or school in?”, “What kind of area is your home in?”, “What is the highest degree or level of school that you have completed?”, “What is your marital status?”, “Are you currently employed, self-employed, out of work and looking for work, out of work but not currently looking for work, a homemaker, a student, military, retired, or unable to work?”, “Do you drive for work 3 or more days a week?”, “About how many times a month do you travel out of town for work?”, “Do you take non-commute trips during the week?”, “If you have kids, how often do you drive them to school or other activities?”, combinations thereof, and/or the like. At processing block 604, the one or more survey answers may be received.

At processing block 606, the one or more survey answers may be correlated to a driver valuation metric. In some embodiments, a percentage (or other indicator) of how often the user is a driver can be estimated using the information gleaned from the one or more survey answers. For example, if the user is single, lives in the city near public transportation, and does not own a car, the driver valuation metric may be estimated at 3%. This may be established using known statistics collected from other users that answered the same survey questions with known driver valuation metrics. Thus, a probability that the user will be the driver on the next trip may be determined based on the driver valuation metric.

Some of the survey answers may be more indicative of a driver valuation metric than others. Thus, in some embodiments, an estimated driver valuation metric for one survey answer may be weighed more heavily or less heavily than an estimated driver valuation metric for another survey answer in determining an individualized probability. For example, if a user does not own a car and the estimated driver valuation metric for users that do not own a car is 5%, that metric can be weighed more heavily than a metric corresponding to marital status, which may correspond less accurately to a driver valuation metric.

FIG. 6B is a flowchart illustrating a method for adjusting a user-estimated driver valuation metric using survey answers according to some embodiments of the invention. The method may be performed by mobile device 101 and/or server 150 of FIG. 1, or mobile device 101 and/or server 201 of FIG. 2, for example. The method of FIG. 6A may be implemented in conjunction with or alternative to any portions of any of the embodiments described herein.

In some embodiments, a driver valuation metric from a user may be adjusted based on one or more survey questions. At processing block 608, one or more survey questions may be displayed on the mobile device. Processing block 608 of FIG. 6B may be similar to processing block 602 of FIG. 6A. At processing block 610, one or more survey answers may be received from the user. Processing block 610 of FIG. 6B may be similar to processing block 604 of FIG. 6A.

Before, after, or concurrently with processing blocks 608-610, a driver valuation metric may be received as user input at processing block 612. The driver valuation metric may correspond to a percentage (or other indicator) of driving events during which the user is the driver of the vehicle as a function of a total number of driving events during which the user is in the vehicle. The driver valuation metric may be received as user input. For example, the user may be prompted with a survey on the mobile device (or any other device) asking how often s/he drives when s/he is in the vehicle. An exemplary interface for inputting a driver valuation metric is shown in FIG. 7. Although shown as a range between 0% and 100%, it is contemplated that any range, any numbers, any letters, and/or any characters or images may be used to indicate the driver valuation metric. Processing block 612 may be similar to processing block 402 of FIG. 4 and/or processing block 502 of FIG. 5.

At processing block 614, the driver valuation metric may be adjusted based on the one or more survey answers received at processing block 610. For example, if the user estimates his or her driver valuation metric at 100%, but the one or more survey questions estimate that the user drives 80% of the time, the driver valuation metric can be adjusted closer to 80%. Thus, a probability that the user will be the driver on the next trip may be determined based on the adjusted driver valuation metric.

It should be appreciated that the specific steps illustrated in FIGS. 3-6B provide particular methods of determining individualized driver predictions according to an embodiment of the present invention. Other sequences of steps may also be performed according to alternative embodiments. For example, alternative embodiments of the present invention may perform the steps outlined above in a different order. Moreover, the individual steps illustrated in FIGS. 3-6B may include multiple sub-steps that may be performed in various sequences as appropriate to the individual step. Furthermore, additional steps may be added or removed depending on the particular applications. One of ordinary skill in the art would recognize many variations, modifications, and alternatives.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. The computer-readable medium may be understood to include one or more computer-readable media of various forms, in various examples.

In the foregoing description, aspects of the application are described with reference to specific embodiments thereof, but those skilled in the art will recognize that the invention is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as performing or being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A system comprising:
a mobile device comprising at least one sensor, wherein the at least one sensor comprises at least one of an accelerometer, a gyroscope, a magnetometer, a GPS, or a compass;
a memory; and
a processor coupled to the memory, wherein the processor is configured to perform operations including:
receiving a driver valuation metric corresponding to an amount of driving events during which a user is a driver of a vehicle as a function of a total number of driving events during which the user is in the vehicle;
determining, using the driver valuation metric, a first probability that the user will be driving the vehicle during a next driving event;
obtaining a first stream of data from a sensor of the at least one sensor of the mobile device;
determining from the first stream of data that the next driving event has initiated;
obtaining a second stream of data from the sensor of the at least one sensor of the mobile device during the next driving event;
determining, using the second stream of data, a second probability that the user is driving the vehicle during the next driving event; and
determining, using the first probability and the second probability, a combined probability that the user is driving the vehicle during the next driving event.

2. The system of claim 1, wherein the driver valuation metric is received as input from the user.

3. The system of claim 1, further comprising:
a display configured to display a survey to the user and to receive the driver valuation metric as input from the user in response to the survey,
wherein determining the first probability that the user will be driving the vehicle during the next driving event comprises:
determining an amount of time elapsed between displaying the survey and receiving the input; and
adjusting the driver valuation metric based on the amount of time.

4. The system of claim 1, wherein determining the first probability that the user will be driving the vehicle during the next driving event comprises:
estimating a historical driver valuation metric corresponding to a percentage of historical driving events during which the user was the driver of the vehicle as a function of a total number of historical driving events during which the user was in the vehicle; and
adjusting the driver valuation metric based on the historical driver valuation metric.

5. The system of claim 4, wherein the historical driver valuation metric is estimated using data from the sensor of the at least one sensor of the mobile device.

6. The system of claim 1, wherein determining the second probability that the user is driving the vehicle during the next driving event comprises at least one of:
determining, using the first stream of data, whether the user entered the vehicle from a left side or a right side of the vehicle;
determining, using the second stream of data, whether the user exited the vehicle from the left side or the right side of the vehicle;
determining, using the second stream of data, usage of the mobile device by the user;
determining a fraction of the next driving event during which a battery of the mobile device is being charged; and
determining whether the mobile device is connected to hands-free technology in the vehicle during the next driving event.

7. The system of claim 1, further comprising, before determining the first probability, but after receiving the driver valuation metric:
facilitating display of a survey question on the mobile device;
receiving input indicative of an answer to the survey question on the mobile device;
adjusting the driver valuation metric in accordance with the answer to the survey question.

8. A system comprising:
a mobile device comprising at least one sensor, wherein the at least one sensor comprises at least one of an accelerometer, a gyroscope, a magnetometer, a GPS, or a compass;
a memory; and
a processor coupled to the memory, wherein the processor is configured to perform operations including:
facilitating display of a survey question on the mobile device;
receiving input indicative of an answer to the survey question on the mobile device;
correlating the answer to the survey question to a driver valuation metric, wherein the driver valuation metric corresponds to an amount of driving events during which a user if a driver of a vehicle as a function of a total number of driving events during which the user is in the vehicle;
determining, using the driver valuation metric, a first probability that the user will be driving the vehicle during a next driving event;
obtaining a first stream of data from a sensor of the at least one sensor of the mobile device;
determining from the first stream of data that the next driving event has initiated;
obtaining a second stream of data from the sensor of the at least one sensor of the mobile device during the next driving event;
determining, using the second stream of data, a second probability that the user is driving the vehicle during the next driving event; and
determining, using the first probability and the second probability, a combined probability that the user is driving the vehicle during the next driving event.

9. The system of claim 8, wherein the survey question is a demographic question.

10. The system of claim 8, wherein the answer is different than the driver valuation metric.

11. A method comprising:
receiving a driver valuation metric corresponding to a percentage of driving events during which a user is a driver of a vehicle as a function of a total number of driving events during which the user is in the vehicle;
determining, using the driver valuation metric, a first probability that the user will be driving the vehicle during a next driving event;
obtaining a first stream of data from a sensor of a mobile device of the user;
determining from the first stream of data that the next driving event has initiated;
obtaining a second stream of data from the sensor of the mobile device of the user during the next driving event;
determining, using the second stream of data, a second probability that the user is driving the vehicle during the next driving event; and
determining, using the first probability and the second probability, a combined probability that the user is driving the vehicle during the next driving event.

12. The method of claim 11, wherein the driver valuation metric is received as input from the user.

13. The method of claim 11, further comprising:
displaying a survey to the user, wherein the driver valuation metric is received as input from the user in response to the survey,
wherein determining the first probability that the user will be driving the vehicle during the next driving event comprises:
determining an amount of time elapsed between displaying the survey and receiving the input; and
adjusting the driver valuation metric based on the amount of time.

14. The method of claim 11, wherein determining the first probability that the user will be driving the vehicle during the next driving event comprises:
estimating a historical driver valuation metric corresponding to a percentage of historical driving events during which the user was the driver of the vehicle as a function of a total number of historical driving events during which the user was in the vehicle; and
adjusting the driver valuation metric based on the historical driver valuation metric.

15. The method of claim 14, wherein the historical driver valuation metric is estimated using data from the sensor of the mobile device.

16. The method of claim 11, wherein determining the second probability that the user is driving the vehicle during the next driving event comprises at least one of:
determining, using the first stream of data, whether the user entered the vehicle from a left side or a right side of the vehicle;
determining, using the second stream of data, whether the user exited the vehicle from the left side or the right side of the vehicle;
determining, using the second stream of data, usage of the mobile device by the user;
determining a fraction of the next driving event during which a battery of the mobile device is being charged; and
determining whether the mobile device is connected to hands-free technology in the vehicle during the next driving event.

17. The method of claim 11, further comprising, before determining the first probability, but after receiving the driver valuation metric:
facilitating display of a survey question on the mobile device;
receiving input indicative of an answer to the survey question on the mobile device; and
adjusting the driver valuation metric in accordance with the answer to the survey question.

18. A method comprising:
facilitating display of a survey question on a mobile device;
receiving input indicative of an answer to the survey question on the mobile device;
correlating the answer to the survey question to a driver valuation metric, wherein the driver valuation metric corresponds to an amount of driving events during which a user if a driver of a vehicle as a function of a total number of driving events during which the user is in the vehicle;
determining, using the driver valuation metric, a first probability that the user will be driving the vehicle during a next driving event;
obtaining a first stream of data from a sensor of a plurality of sensors of the mobile device;
determining from the first stream of data that the next driving event has initiated;
obtaining a second stream of data from the sensor of the plurality of sensors of the mobile device during the next driving event;
determining, using the second stream of data, a second probability that the user is driving the vehicle during the next driving event; and
determining, using the first probability and the second probability, a combined probability that the user is driving the vehicle during the next driving event.

19. The method of claim 18, wherein the survey question is a demographic question.

20. The method of claim 18, wherein the answer is different than the driver valuation metric.
